(19) United States
(12) Patent Application Publication
(10) Pub. No.: US 2021/0240915 A1
(43) Pub. Date: Aug. 5, 2021

(54) RECONSTITUTION OF WEB ASSETS

(71) Applicant: Hewlett-Packard Development Company, L.P., Spring, TX (US)

(72) Inventor: Christoph Graham, Spring, TX (US)

(73) Assignee: Hewlett-Packard Development Company, L.P., Spring, TX (US)

(21) Appl. No.: 17/048,746

(22) PCT Filed: Sep. 26, 2018
(86) PCT No.: PCT/US2018/052940

§ 371 Date: Oct. 19, 2020

(51) Int. Cl. G06F 40/143; G06F 16/958; G06F 40/205; G06F 40/103

(52) U.S. Cl. CPC G06F 40/143; G06F 16/986; G06F 40/103; G06F 40/205; G06F 16/972

(57) ABSTRACT

In an example implementation according to aspects of the present disclosure, a method, a computing device and a computer readable medium reconstitute web assets. A web page may be parsed into a document object model. A selection of web assets within the document object model may be received. A first location in the document object model may be identified corresponding to the selection. Formatting information, behaviors, and data corresponding to the selection is identified. The selection at the first location and accompanying formatting information, behaviors and data may be reconstituted into a second location in a second document object model. A second web page based on the second document model may be rendered.

### BACKGROUND

Web browsers render web pages with dynamic assets and corresponding formatting information to provide the user with a rich media experience.

### BRIEF DESCRIPTION OF THE DRAWINGS

FIG. 1 illustrates the reconstitution of web assets from a first web page to a second web page according to an example;

FIG. 2 illustrates the reconstitution of web assets from a first document object model to a second document object model according to an example;

FIG. 3 illustrates the reconstitution of web assets with formatting information in accordance with an example of the present disclosure;

FIG. 4 is a flow diagram illustrating a method to reconstitute web assets, according to an example; and

FIG. 5 is a diagram of a computing device to reconstitute web assets, according to an example.

### DETAILED DESCRIPTION

Moving web assets from a rendered web page to another graphical or text editor may present issues. Often the essential elements are not copied and lost or not copied correctly, and formatting is lost. Additionally, limitations of the receiving application may not allow for the proper insertion of the reconstituted graphical and text elements and their behaviors, leading to a loss of formatting information and behaviors. Described herein is a method, and non-transitory computer readable media for reconstituting web assets from a source to a destination.

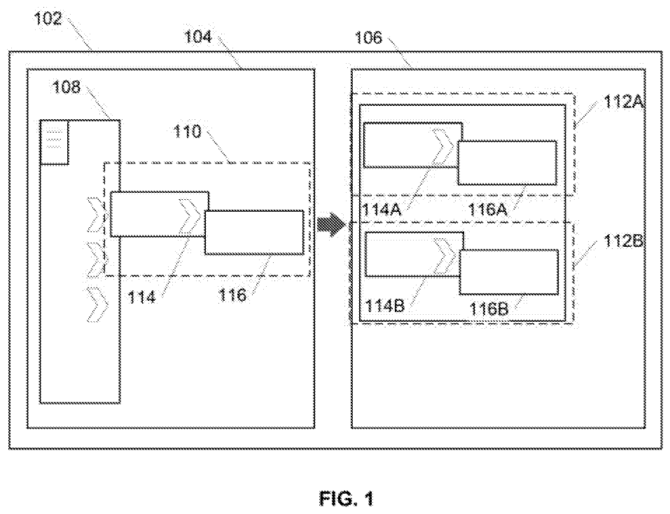

FIG. 1 illustrates the reconstitution of web assets from a first web page to a second web page according to an example. According to one example, the reconstitution of web assets may include a rendered web page view. The rendered web page view may be based in a web browser 102. In some implementations, the rendered web page view may be instantiated as tabs within one instance of a web browser. In other implementations, the rendered web page view may occur in separate web browser processes. In other implementations, the rendered web page view may occur across applications which are not web browsers but utilize a document object model (DOM) and may be implemented with web browser backend technology (e.g. WebKit). Web browsers suitable for rendering a web page including dynamic web assets may include Microsoft Internet Explorer, Google Chrome, Apple Safari, and Mozilla Firefox.

A first web page 104 may host a plurality of dynamic web assets 108. The provider of the first web page 104 may determine the number and type of web assets. Additionally, the web assets may be procedurally generated utilizing web scripting languages such as JavaScript. The first web page 104 may be received from a provider utilizing web-based transmission protocol (e.g. HTTP, HTTPS), and parsed by the web browser 102. The parsing may include utilizing a third-party web rendering engine to process the received web page. The parsing may include interpreting tag values and developing a DOM for the received webpage. The DOM may include a tree structure representing web assets within the webpage, as well as relationships between the web assets. A portion of the plurality of dynamic web assets 108 may be identified for transfer to be reconstituted. The selection of dynamic web assets 110 may be highlighted by a user. The user may utilize a tool to select the dynamic web assets 110 to be reconstituted. The tool may interact with the DOM to identify the portions of the DOM corresponding to the fully rendered web asset. In this interaction, the tool may modify values within the DOM to change attributes of the web assets to visualize the selection.

A second web page 106 may be utilized to receive a selection of dynamic web assets 110. A user may “drag and drop” to transfer the selection of dynamic web assets 110 into a second web page 106. The selection of dynamic web assets 110 may include web assets 114, 116. The web assets 114, 116 may be atomic elements or leaves within the DOM. In another implementation, the web assets 114, 116 may represent branches or twigs within the DOM tree structure. The second web page 106 may be a DOM implemented text and graphics editor with read and write permissions for the user. In the selection of dynamic web assets 110. In another implementation, the second web page 106 may be a rich media document editor supported by a DOM. Upon the transfer, the reconstituted dynamic web assets 112A, 112B may be included into the second web page. The reconstituted dynamic web assets 112A, 112B may be included in the DOM corresponding to the second web page 106. Additionally, the reconstituted dynamic web assets 112A, 112B may also capture executable code behavior, such as JavaScript connections within the web assets well as state information such as data and variables used to render information or manipulate behaviors.

Within the reconstituted dynamic web assets 112A, 112B may be reconstituted web assets 114A, 1146, 116A, 116B. The reconstituted web assets 114A, 114B, 116A, 116B may include the same characteristics of the web assets 114, 116 that existed in the first web page 104. The reconstituted dynamic web assets 112A, 112B may be inserted in the second web page 106 within different structures and contexts than compared to the location of the selection of dynamic web assets 110. For example, the plurality of web assets 108 within the first web page 104 may be a complete navigation pane used to navigate a website. A user may choose to select only a subsection of relevant navigation panes as the selection of dynamic web assets 110 and move them to the second web page 106 out of the original context of navigation pane. Additionally, a user may duplicate the selection of dynamic web assets 110 within the second web page 106, where the selection becomes two unique reconstituted dynamic web assets 112A, 112B. In one implementation, internal reconstituted web assets 114A, 116A may be linked to the parent reconstituted dynamic web asset 112A and untethered or linked to the non-parent reconstituted dynamic web asset 112B.

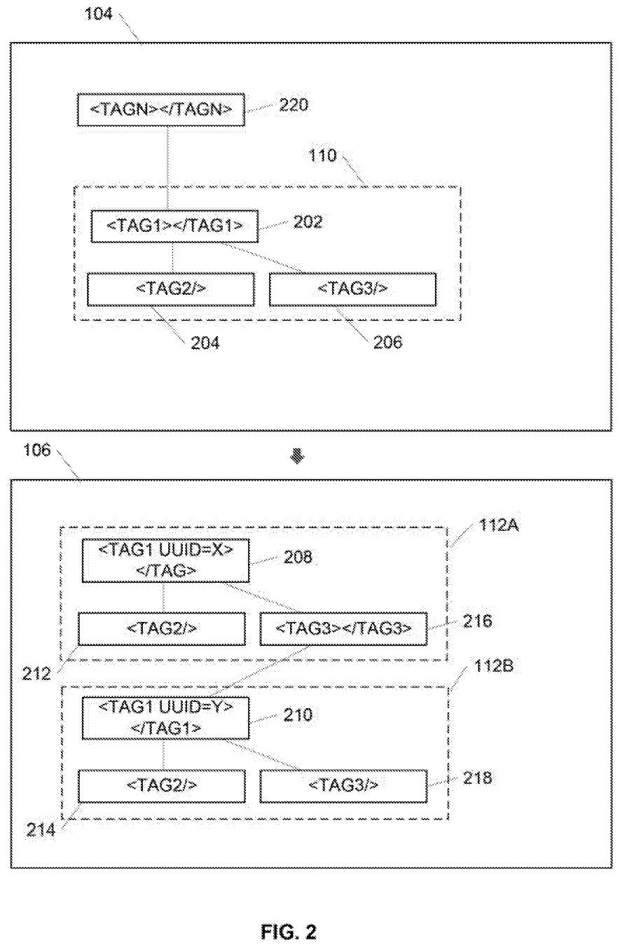

FIG. 2 illustrates the reconstitution of web assets from a first document object model to a second document object model according to an example. FIG. 2 refers to the internal data structure representation of a web page as illustrated in FIG. 1.

As depicted in FIG. 1, a first web page 104 may also include a DOM representation. The DOM may include a selection of dynamic web assets 110 represented as nodes within a DOM tree. Each of the selected dynamic web assets 110 may be trunks, branches, twigs or leaves within a DOM tree. Within the selection of dynamic web assets 110, selected document object model elements 202, 204, 206 may correspond to the DOM elements of the web assets 114, 116. Unselected elements from the plurality of dynamic web assets 108 may be represented as unselected DOM elements 220, which may not be reconstituted in the second web page 106.

The selected DOM elements 202, 204, 206 may include identifiers internal to describe the element. Identifiers may be implemented as tags which identify properties of the selected DOM elements 202, 204, 206. The properties may include rendering details and as well as relationship details between selected DOM elements 202, 204, 206. In one implementation, the tag may utilize an identifier to indicate that the selected DOM element 202 corresponds to a top-level menu item, while the tags utilized for selected DOM elements 204, 206 correspond to leaf menu items and graphics associated with the menu.

Likewise, as described above in FIG. 1, a second web page 106 may also include a DOM representation. The second web page 102 DOM model may include reconstituted dynamic web assets 112A, 112B. As both of the reconstituted dynamic web assets 112A, 112B represented originate from the same selection of dynamic web assets 110, they may be distinguished by an identifier. The identifier may be inserted in the root node 208, 210 within the reconstituted dynamic web assets 112A, 112B. The identifier may be inserted as a key value pair associated with the root node within the DOM. For example, a universally unique ID (UUID) may be utilized for distinguishing the reconstituted dynamic web assets 112A, 112B, however other unique identifiers may be utilized as well. Once the root nodes 208, 210 include identifiers, other reconstituted DOM elements 212, 214, 216, 218 may be inserted within the DOM corresponding to the second web page 106. In some implementations, reconstituted dynamic web assets 112A may be inserted into other reconstituted dynamic web assets 112B as illustrated with the relationship between the reconstituted DOM element 216 and root node 210.

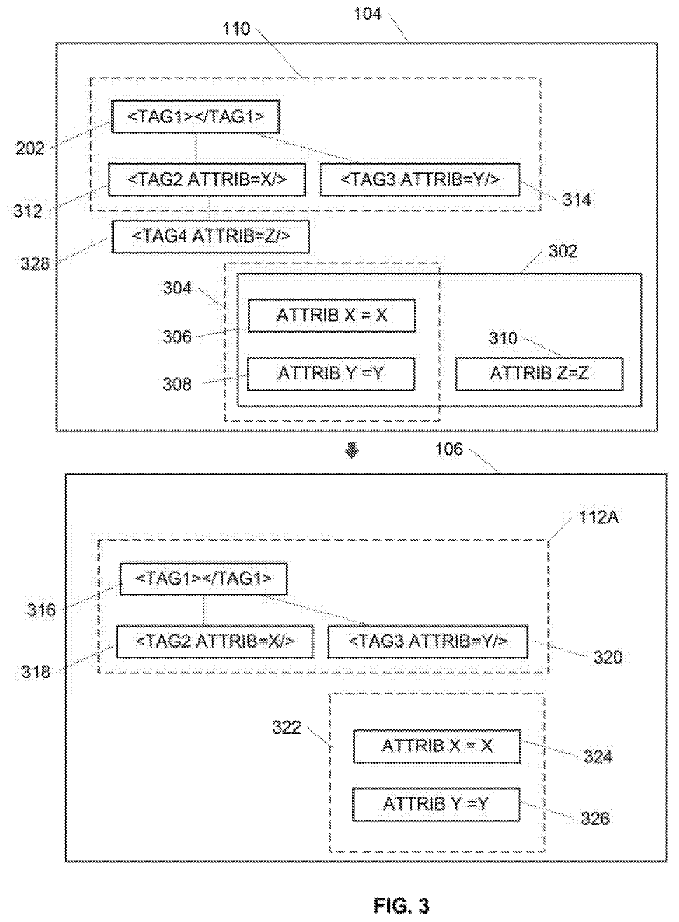

FIG. 3 illustrates the reconstitution of web assets with formatting information in accordance with an example of the present disclosure. As depicted in FIG. 2, a first web page 104 may also include a DOM representation and formatting information. The DOM may include a selection of dynamic web assets 110 represented as nodes within a DOM tree. Additionally, outside of the DOM, may be formatting information 302 corresponding to elements within the DOM. An example of formatting information 302 includes but is not limited to cascading stylesheets (CSS), HTML attributes, or JavaScript variables and code representing format behavior. The formatting information 302 may include information corresponding to various nodes within the DOM. The formatting information 302 may allow for referencing commonly used formatting details that affect one or more elements within the DOM. By maintaining one formatting information 302 container that is referenced by DOM elements, memory utilization for the DOM may be minimized.

The DOM representation for the selection of dynamic web assets 110 may include selected document object model elements 202 and selected DOM elements with formatting information 312, 314. Additionally, within the DOM may also exist unselected DOM elements with formatting information 328. Within the formatting information 302 may include formatting information for selected DOM elements 304. Within the formatting information for selected DOM elements 304, may include formatting attributes for selected DOM elements 306,308. Additionally, within the formatting information 302 may be formatting attributes for unselected DOM elements 310.

The selected DOM elements with formatting information 312, 314 may reference attributes within the formatting information 302. The referencing may include keyword value pairs identifying the corresponding formatting information. As illustrated selected DOM element with formatting information 312 includes an “ATTRIB=X” keyword value pair. The keyword value pair may correspond to formatting attribute for selected DOM element 306 within the formatting information 302.

As depicted in FIG. 2, a second web page 106 may also include a DOM representation and formatting information. Within the DOM corresponding to the second web page 106 may include reconstituted dynamic web assets 112A. The reconstituted dynamic web assets 112A may include reconstituted DOM elements 316, 318, 320. In transferring the selected dynamic web assets 110 to the DOM corresponding to the second web age, the reconstituted DOM elements 316, 318, 320 may create reconstituted formatting information 322. The reconstituted formatting information 322 may include reconstituted formatting attributes for reconstituted DOM elements 324, 326. In some implementations formatting attributes for unselected DOM elements 310 may not be copied into the DOM corresponding to the second web page. Reconstituted formatting information 322 may be stored and referenced in a separate data structure similar in form to the originating format, however omitting any necessary formatting attributes. By transferring the formatting information along with the selected elements, the form and function of the selected web assets remains consistent from the first web page 104 to the second web page 106.

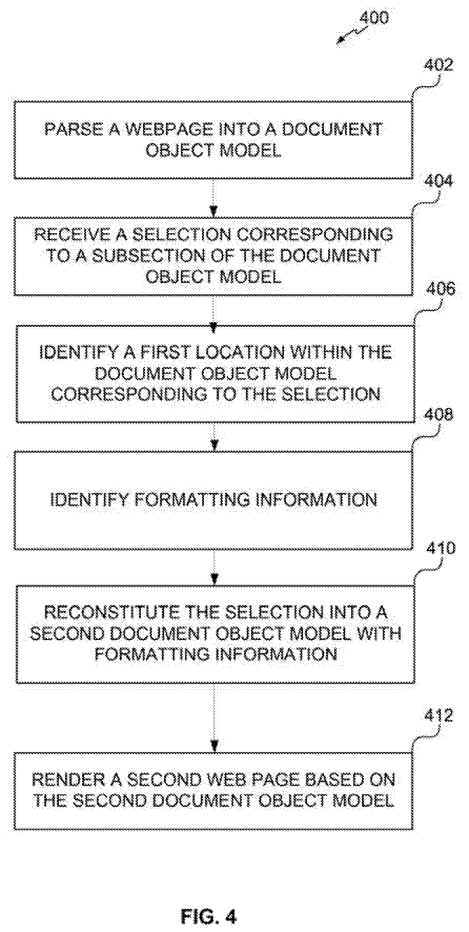

FIG. 4 is a flow diagram illustrating a method to reconstitute web assets, according to an example.

At step 402, a webpage may be parsed into a DOM. The parsing of the webpage may be processed by a third-party web page parsing library capable of converting the webpage hypertext markup language (HTML) into a DOM. In one implementation the parsing may be done by the Xerces™ library (Xerces is a trademark of The Apache Software Foundation). In another implementation, the webpage may be received in DOM form as a memory transfer from another application. The parsing results in a DOM object in addressable memory space.

At step 404 a selection corresponding to a subsection of the DOM may be received. The selection corresponding to the subsection of the DOM may include a trunk, branch, twig or leaf within the DOM and any children down the tree. In another implementation, individual elements with no children or parents within the DOM may be selected. In another implementation a combination of individual elements and branches of elements may be selected.

At step 406, a first location within the DOM corresponding to the selection may be identified. The first location may correspond with the addressable memory space of the selected DOM elements. The first location may correspond with the DOM of the webpage.

At step 408, formatting information corresponding to the selection of dynamic web assets is identified. The formatting information may include formatting attributes corresponding to elements or web assets that are referenced within the elements or web assets within the DOM. The formatting information may be identified in reference data included within the first web page. In one implementation, formatting information not utilized by the selection corresponding to a subsection of the DOM may not be identified.

At step 410, the selection may be reconstituted into a second DOM with the formatting information. The reconstitution may include copying a tree data structure within the DOM from the first location to a second location within the second DOM. The second location within the second DOM may correspond to a placement of the selection within a webpage representing the second DOM. The second location in the second document model object corresponds with a user specified location on the second web page. Additionally, the portion of formatting information corresponding to the selection of dynamic web assets may be identified. By traversing the DOM tree structure, utilized formatting attributes may be identified and stored in a table for future reference. The portion of formatting information may be copied from the first location in the DOM to the second location within the second DOM. In another implementation, the portion of formatting information may be stored separately from the second DOM. In an example where the second DOM already exists, the selection may be inserted into the tree, and the elements in the tree are updated to reference the new selection. In another implementation, upon reconstituting the selection into the second DOM, a unique identifier may be assigned to the reconstituted selection. The unique identifier may be utilized to differentiate two reconstituted selections including the same source web assets. A UUID or other identifier may be utilized to identify the reconstituted selection.

At step 412, a second web page may be rendered based on the second DOM. The web browser may render the second web page by traversing the newly formed second DOM with the stored formatting attributes.

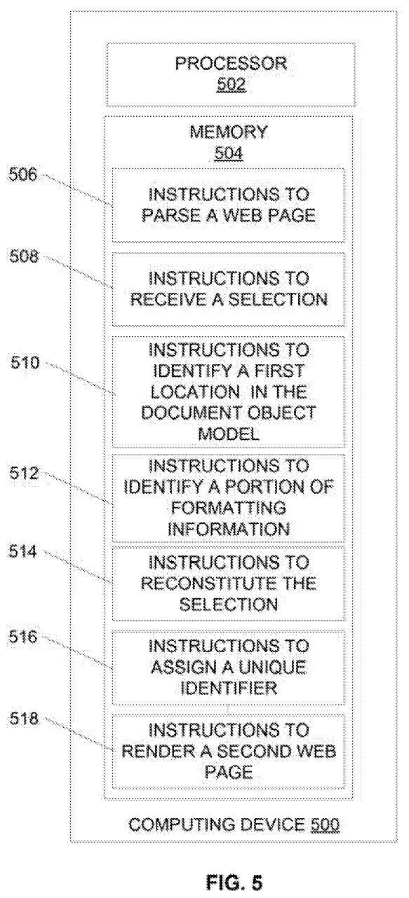

FIG. 5 is a diagram of a computing device to reconstitute web assets, according to an example. The computing device 500 depicts a processor 502 and a memory 504 and, as an example of the computing device 500 performing its operations, the memory 504 may include instructions 506-518 that are executable by the processor 502. Thus, memory 504 can be said to store program instructions that, when executed by processor 502, implement the components of the computing device 500. The executable program instructions stored in the memory 504 include, as an example, instructions to receive a temperature 506, instructions to retrieve a luminous value 508, instructions to determine a corrected luminous value 510, instructions to determine a voltage value 512, and instructions to apply the voltage value 514. In another implementation, referring back to FIG. 4, the memory 504 may include instructions to execute the steps of the method described in steps 402-412.

Memory 504 represents generally any number of memory components capable of storing instructions that can be executed by processor 502. Memory 504 is non-transitory in the sense that it does not encompass a transitory signal but instead is made up of at least one memory component configured to store the relevant instructions. As a result, the memory 504 may be a non-transitory computer-readable storage medium. Memory 504 may be implemented in a single device or distributed across devices. Likewise, the processor 502 represents any number of processors capable of executing instructions stored by memory 504. The processor 502 may be integrated in a single device or distributed across devices. Further, memory 504 may be fully or partially integrated in the same device as the processor 502, or it may be separate but accessible to that device and processor 502.

In one example, the program instructions 506-514 can be part of an installation package that when installed can be executed by processor 502 to implement the components of the computing device 500. In this case, memory 504 may be a portable medium such as a CD, DVD, or flash drive or a memory maintained by a server from which the installation package can be downloaded and installed. In another example, the program instructions may be part of an application or applications already installed. Here, memory 504 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A method comprising:
parsing a web page into a document model object, wherein the web page comprises a plurality of dynamic web assets;
receiving a selection of the dynamic web assets corresponding to a subsection of the document model object;
identifying a first location within the document object model of the selection of dynamic web assets;
identifying formatting information corresponding to the selection of dynamic web assets;
reconstituting the selection of dynamic web assets from the first location and the formatting information, into a second location in a second document model object; and
rendering a second web page based on the second document model object.

2. The method of claim 1 wherein the formatting information comprises one or more entries in a cascading style sheet.

3. The method of claim 1, the reconstituting comprising:
copying a tree data structure from the first location to the second location;
identifying a portion of the formatting information corresponding to the selection of dynamic web assets; and
copying the portion from the first location to the second location.

4. The method of claim 1, wherein the subsection of the document model object comprises a portion of a tree data structure.

5. The method of claim 1, wherein the second location in the second document model object corresponds with a user specified location on the second web page.

6. A computing device comprising:
a memory having instructions stored thereon and
a processor configured to perform, when executing the instructions to:
parse a web page into a document model object, wherein the web page comprises a plurality of dynamic web assets;
receive a selection of the dynamic web assets corresponding to a subsection of the document model object;
identify a first location within the document model object of the selection of dynamic web assets;
identifying a portion of the formatting information corresponding to the selection of dynamic web assets;
reconstitute the selection of dynamic web assets from the first location and the formatting information, into a second location in a second document model object;
assign a unique identifier to the reconstituted selection of dynamic web assets within the second document model object; and
render a second web page based on the second document model object.

7. The computing device of claim 6 wherein the formatting information comprises one or more entries in a cascading style sheet.

8. The computing device of claim 6, the reconstituting comprising:
copying a tree data structure from the first location to the second location;
replacing the portion of the formatting information to a second formatting information corresponding to the second document model object; and
copying the portion from the first location to the second location.

9. The computing device of claim 6, wherein the subsection of the document model object comprises a portion of a tree data structure.

10. The computing device of claim 6, wherein the second location in the second document model object corresponds with a user specified location on the second web page.

11. A non-transitory computer-readable storage medium encoded with instructions executable by a computing device that, when executed, cause the computing device to:
receive a web page as a document model object, wherein the web page comprises a plurality of dynamic web assets;
receive a selection of the dynamic web assets corresponding to a subsection of the document model object;
identify a first location within the document model object of the selection of dynamic web assets;
identify formatting information corresponding to the selection of dynamic web assets;
reconstitute the selection of dynamic web assets from the first location and the formatting information, into a second location in a second document model object;
assign a unique identifier to the copied selection of dynamic web assets within the second document model object; and
render a second web page based on the second document model object.

12. The medium of claim 11 wherein the formatting information comprises one or more entries in a cascading style sheet.

13. The medium of claim 11, the reconstituting comprising:
copying a tree data structure from the first location to the second location;
identifying a portion of the formatting information corresponding to the selection of dynamic web assets; and
copying the portion from the first location to the second location.

14. The medium of claim 11, wherein the subsection of the document model object comprises a portion of a tree data structure.

15. The medium of claim 11, wherein the second location in the second document model object corresponds with a user specified location on the second web page.
